(19) United States
(12) Patent Application Publication
(10) Pub. No.: US 2011/0137868 A1
(43) Pub. Date: Jun. 9, 2011

(54) STORAGE SWITCH AND STORAGE AREA SIZE CHANGE METHOD

(75) Inventors: Koutarou SASAGE, Kawasaki (JP); Hidetaka Joshima, Numazu (JP)

(73) Assignee: FUJITSU LIMITED, Kawasaki (JP)

(21) Appl. No.: 12/730,531

(22) Filed: Mar. 24, 2010

(30) Foreign Application Priority Data
Mar. 27, 2009 (JP) 2009-079194

(51) Int. Cl. G06F 17/30

(52) U.S. Cl. 707/655; 707/E17.005

(57) ABSTRACT

A storage switch includes: a section 2 that creates a destination virtual disk having a capacity larger than that of a source virtual disk; a section 3 that creates a first area in the destination storage area, creates a mirror area for performing control so that processing corresponding to a write request to the source virtual disk is executed between the first area and source virtual disk, creates a second area in the destination virtual disk, creates a mirror area for performing control so that processing corresponding to a request to the second area is executed in the second area, and combines the created mirror areas to create a combined mirror area; a section 4 that connects the combined mirror area to a virtual target; and a section 5 that performs data migration from the source virtual disk to the first area.

### CROSS-REFERENCE TO RELATED APPLICATIONS

This application is based upon and claims the benefit of priority of the prior Japanese Patent Application No. 2009-079194, filed on Mar. 27, 2009, the entire contents of which are incorporated herein by reference.

### FIELD

Embodiments of the present invention relate to a storage switch for changing the storage area size of a virtual disk and a method of changing the storage area size.

### BACKGROUND

Continuous operation of a business system increases the amount of data to be managed in the system and, accordingly, it becomes preferable to ensure a large storage area. This requires preparation of an additional physical disk such as a magnetic disk drive having a large storage capacity, creation of a virtual disk having a large storage capacity based on the prepared physical disk, and performance of migration (data migration). Generally, in the migration, a physical disk is newly connected to a storage switch so as to migrate data from a currently-used virtual disk to the physical disk.

### SUMMARY

According to an aspect of the present invention, there is provided a storage switch including: a migration destination storage area creation section that creates a data migration destination storage area which is a storage area to which data is migrated and has a capacity larger than that of a data migration source storage area which is a storage area from which data is migrated; a first mirror area creation section that creates, in the data migration destination storage area, a first storage area having a size equal to that of the data migration source storage area and creates a first mirror area for performing control so that processing corresponding to a write request issued from a host to the data migration source storage area is executed between the first storage area and data migration source storage area; a second mirror area creation section that creates, in the data migration source storage area, a second storage area different from the first storage area and creates a second mirror area for performing control so that processing corresponding to a write request issued from a host to the second storage area is executed in the second storage area; a combined mirror area creation section that combines the first and second mirror areas to create a combined mirror area; a virtual target connection section that connects a virtual target serving as an interface for receiving a read/write request issued from a host to the combined mirror area; and a data migration section that performs data migration from the data migration source storage area to the first storage area.

Further, according to another aspect of the present invention, there is provided a storage switch including: a migration destination storage area creation section that creates a data migration destination storage area which is a storage area to which data is migrated and has a capacity smaller than that of a data migration source storage area which is a storage area from which data is migrated; a first mirror area creation section that creates, in the data migration source storage area, a first storage area having a size equal to that of the data migration destination storage area and creates a first mirror area for performing control so that processing corresponding to a write request issued from a host to the data migration source storage area is executed between the first storage area and data migration source storage area; a virtual target connection section that connects a virtual target serving as an interface for receiving a read/write request issued from a host to the first mirror area; and a data migration section that performs data migration from the data migration source storage area to the first storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a hardware configuration of a storage switch according to a first embodiment of the present invention;

FIG. 2 is a view illustrating an example of a functional block of the storage switch according to the first embodiment;

FIG. 3 is a view for explaining an example of a virtual disk management table according to the first embodiment;

FIG. 4 is a view for explaining an example of a mirror disk management table according to the first embodiment;

FIG. 5 is a view for explaining an example of a VT connection disk list according to the first embodiment;

FIG. 6 is a view for explaining an example of a VT management table according to the first embodiment;

FIGS. 7A to 7C are views for explaining an example of operation of Case 1 according to the first embodiment;

FIG. 8 is a view for explaining an example of a case where migration processing has been canceled in Case 1 according to the first embodiment;

FIGS. 9A to 9C are views for explaining an example of operation of Case 2 according to the first embodiment;

FIG. 10 is a view for explaining an example of a state where the storage configuration has been restored to a backup in the processing of Case 2 according to the first embodiment;

FIGS. 11A to 11C are views for explaining an example of operation of Case 3 according to the first embodiment;

FIG. 12 is a view for explaining an example of operation of Case 4 according to the first embodiment;

FIG. 13 is a flowchart illustrating an example of processing performed by a processing controller according to the first embodiment;

FIG. 14 is a flowchart illustrating an example of the processing of Case 1 according to the first embodiment;

FIGS. 15A and 15B are views each illustrating an example of transition of data structure in the processing of Case 1 according to the first embodiment;

FIG. 16 is a flowchart illustrating an example of the processing of Case 2 according to the first embodiment;

FIGS. 17A and 17B are views each illustrating an example of transition of data structure in the processing of Case 2 according to the first embodiment;

FIG. 18 is a first flowchart illustrating an example of the processing of Case 3 according to the first embodiment;

FIG. 19 is a second flowchart illustrating an example of the processing of Case 3 according to the first embodiment;

FIGS. 20A to 20C are views each illustrating an example of transition of data structure in the processing of Case 3 according to the first embodiment;

FIG. 21 is a first flowchart illustrating an example of the processing of Case 4 according to the first embodiment;

FIG. 22 is a second flowchart illustrating an example of the processing of Case 4 according to the first embodiment;

FIGS. 23A and 23B are views each illustrating an example of transition of data structure in the processing of Case 4 according to the first embodiment;

FIG. 24 is a view illustrating an example of a functional block of the storage switch according to a second embodiment of the present invention; and

FIGS. 25A and 25B are views for explaining an example of operation of the storage switch according to the second embodiment.

### DESCRIPTION OF EMBODIMENT(S)

Hereinafter, problems in conventional technology will be described.

Repetitive expansion of the virtual disk area causes one virtual disk to be distributed among a plurality of physical disks or to be assigned to discontinuous areas even in a single physical area, resulting in a reduction in space efficiency and access efficiency.

Although a virtual disk having a plurality of Extents can be integrated into one Extent in conventional migration, there is a restriction that the capacities of a virtual disk as a copy source and a virtual disk of a copy destination need to be equal to each other in the migration. Further, even when a capacity of the copy destination larger than the current capacity thereof is specified, an access to the expanded storage area in the copy destination virtual disk is disabled until the migration is completed.

A newly added physical disk often has a capacity larger than that of a currently used physical disk. In this case, a user needs to wait until the migration is completed before he or she starts the expansion of a storage area, so that he or she needs to perform at least two steps (migration processing and storage area expansion), resulting in an increase in user's workload.

Further, in general, the capacity of the virtual disk is unable to be reduced. Accordingly, in the case where a capacity smaller than one estimated at the creation time of the virtual disk suffices, a useless storage area occurs.

The embodiments of the present invention have been made to solve the above problems, and an object thereof is to provide a storage switch and a method of changing the storage area size capable of allowing access to be made to the expanded storage area without need of waiting for completion of the migration.

Embodiments of the present invention will be described below with reference to the accompanying drawings.

### First Embodiment

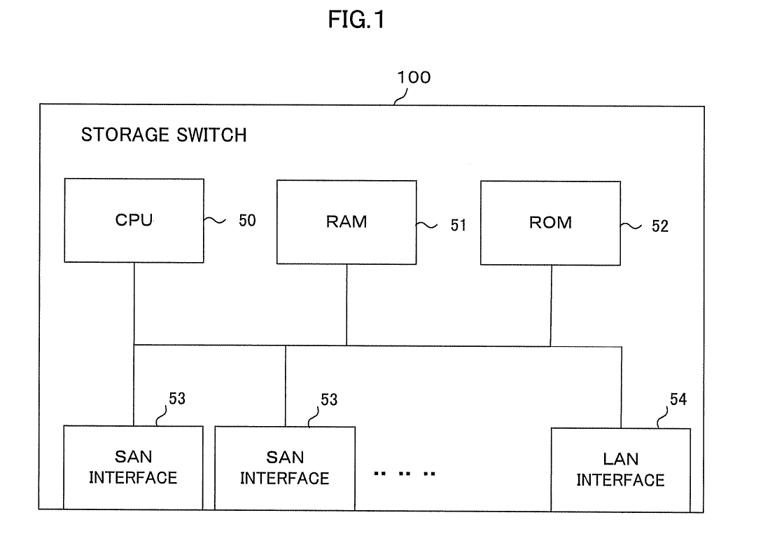

FIG. 1 illustrates an example of a hardware configuration of a storage switch according to a first embodiment. A storage switch 100 includes a CPU (Central Processing Unit) 50 serving as a processing unit, an RAM (Random Access Memory) 51 which is a volatile memory device, and an ROM (Read Only Memory) 52 which is a non-volatile memory device in which firmware for realizing the present embodiment is previously stored. The storage switch 100 further includes two or more SAN (Storage Area Network) interfaces 53 for SAN connection to not illustrated physical magnetic disk drive(s) and not illustrated operation server(s) (host(s)) that uses virtual disk(s). The storage switch 100 further includes a LAN (Local Area Network) interface 54 that can connect to a not illustrated management server that instructs the storage switch 100 to execute migration processing.

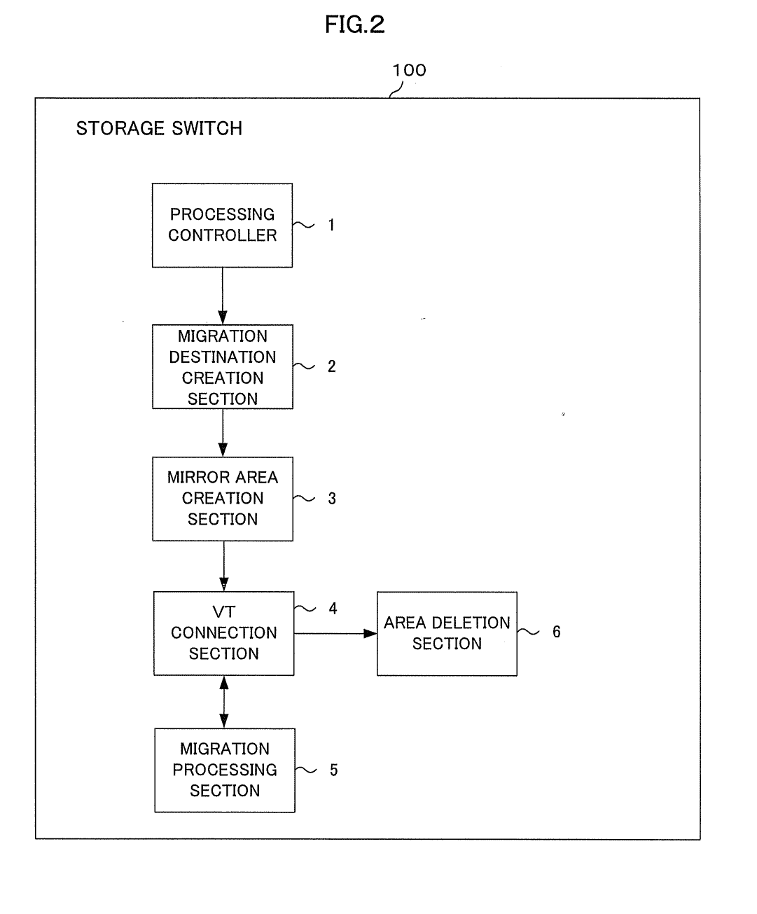

FIG. 2 illustrates an example of a functional block of the storage switch 100 according to the first embodiment. The storage switch 100 includes a processing controller 1, a migration destination creation section 2 (migration destination storage area creation section), a mirror area creation section 3 (first mirror area creation section, second mirror area creation section, combined mirror area creation section), a VT connection section 4 (virtual target connection section, connection switching section), a migration processing section 5 (data migration section), and an area deletion section 6 (invalidation section).

The migration destination creation section 2 creates a migration destination virtual disk (data migration destination storage area) which is a storage area having a capacity larger than that of a migration source virtual disk (data migration source storage area).

The mirror area creation section 3 creates, in the migration destination virtual disk, a storage area (in the explanation of FIG. 2, referred to as a first storage area) having a size equal to that of the migration source virtual disk. Further, the mirror area creation section 3 creates a mirror area (in the explanation of FIG. 2, referred to as a first mirror area) for performing control so that processing corresponding to a write request issued from the operation server to the migration source virtual disk is executed between the first storage area and migration source virtual disk.

Further, the mirror area creation section 3 creates, in the migration source virtual disk, a storage area (in the explanation of FIG. 2, referred to as a second storage area) different from the first storage area. Furthermore, the mirror area creation section 3 creates a mirror area (in the explanation of FIG. 2, referred to as a second mirror area) for performing control such that processing corresponding to a write request issued from the operation server to the second storage area is executed in the second storage area.

Further, the mirror area creation section 3 combines the abovementioned first and second mirror areas to create a combined mirror area.

The VT connection section 4 connects a virtual target (hereinafter, abbreviated as VT) serving as a virtual interface for receiving a read/write request issued from the operation server to the combined mirror area.

Further, the VT connection section 4 switches the connection destination of the VT from the combined mirror area to migration destination virtual disk upon completion of the migration processing performed by the migration processing section 5.

The migration processing section 5 performs data migration (migration processing) from the migration source virtual disk to first storage area.

The area deletion section 6 cancels the mirror areas and deletes (invalidates) the storage area of the migration source virtual disk so as to prevent the operation server from accessing it after the VT connection section 4 switches the VT connection destination to the migration destination virtual disk. Note that, there is a case where the storage area of the migration source virtual disk remains without being deleted according to need (detail of which will be described later).

Other functions of the mirror area creation section 3 and functions of the processing controller 1 will be described later. The respective functional blocks illustrated in FIG. 2 are realized by cooperation between each hardware illustrated in FIG. 1 and firmware. That is, firmware previously stored in the ROM 52 is loaded on the RAM 51, and the loaded firmware is executed by the CPU 50. The virtual disk(s) is realized by assigning virtual disk volume(s) to the storage area of a magnetic disk drive(s) connected to the storage switch 100 through the SAN interfaces 53.

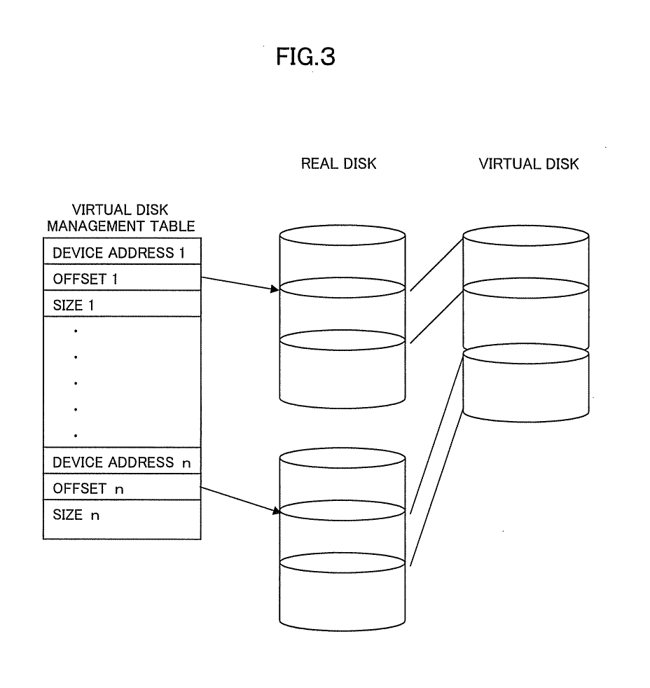

Here, the virtual disk will be described. In the storage switch 100, the virtual disk is managed and controlled by a virtual disk management table. FIG. 3 is a view schematically illustrating the virtual disk management table managing a plurality of real disks. The virtual disk management table is composed of a set of address information (device address 1, . . . , device address n) for identifying the real disks, offset (offset 1, . . . , offset n) of an area to be assigned to the virtual disk, and a size (size 1, . . . , size n).

In the storage switch 100, the address on the virtual disk corresponding to an I/O request issued from the operation server is converted into the address on a real disk according to the virtual disk management table, and I/O is issued to the real disk according to the obtained address.

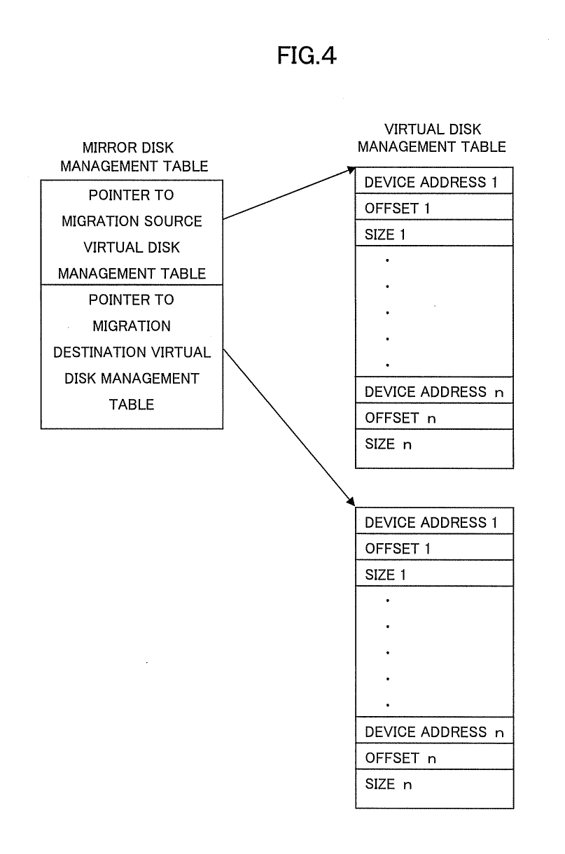

When a mirror virtual disk is created, a mirror disk management table illustrated in FIG. 4 is created. The mirror virtual disk performs I/O control according to the mirror disk management table. The mirror disk management table has a pointer to the virtual disk management table of the migration source virtual disk and a pointer to the virtual disk management table of the migration destination virtual disk.

Write processing to the mirror disk is executed for both the source and destination virtual disks according to the mirror disk management table. Read processing is executed for the migration source virtual disk.

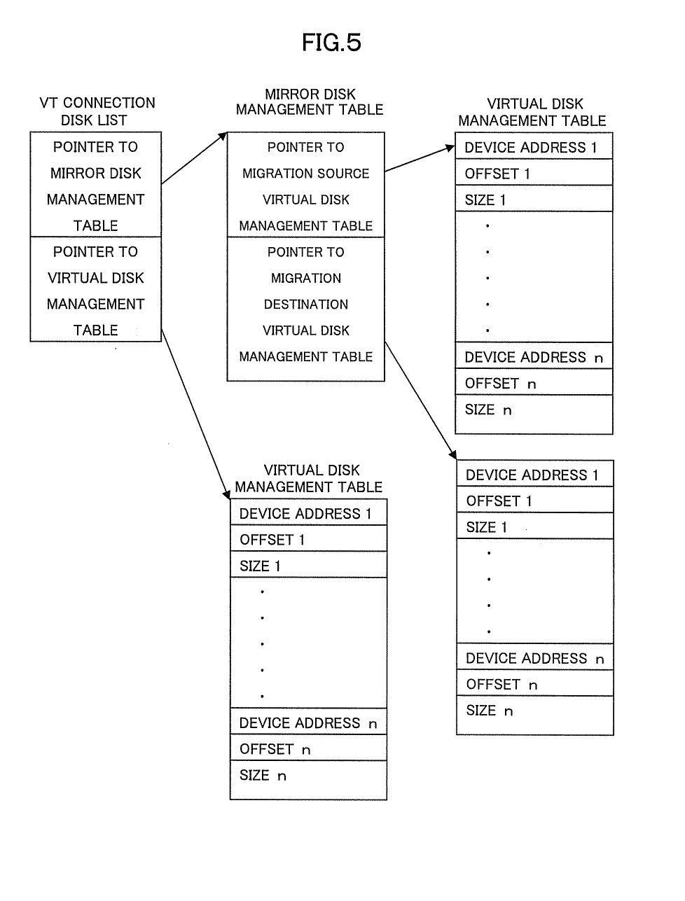

The storage switch 100 creates a VT connection disk list and thereby can integrate the mirror disk and virtual disk according to the VT connection disk list to create a new virtual disk. As illustrated in FIG. 5, the VT connection disk list has, e.g., a pointer to the mirror disk management table and a pointer to the virtual disk management table.

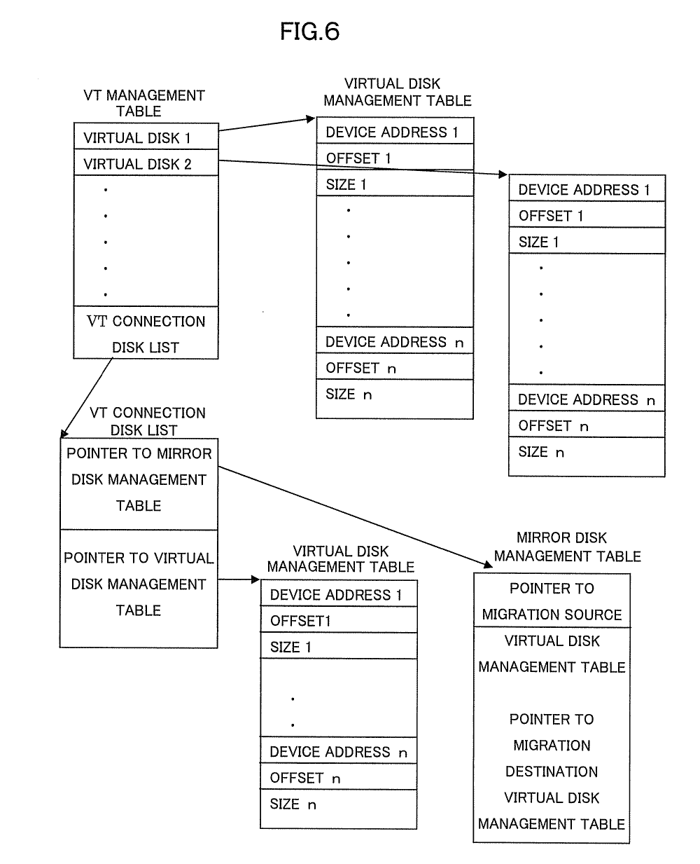

The VT serving as a virtual interface for receiving a read/write request issued from the operation server has a VT management table. The VT performs control such that the read and write requests from the operation server are issued to the virtual disk and the like registered in the VT management table. As illustrated in FIG. 6, the VT management table points the virtual disk management tables of a plurality of virtual disks under control thereof. In the case where the virtual disk is constructed by integration of the mirror disk and virtual disk, a pointer to the VT connection disk list is set in the VT management table.

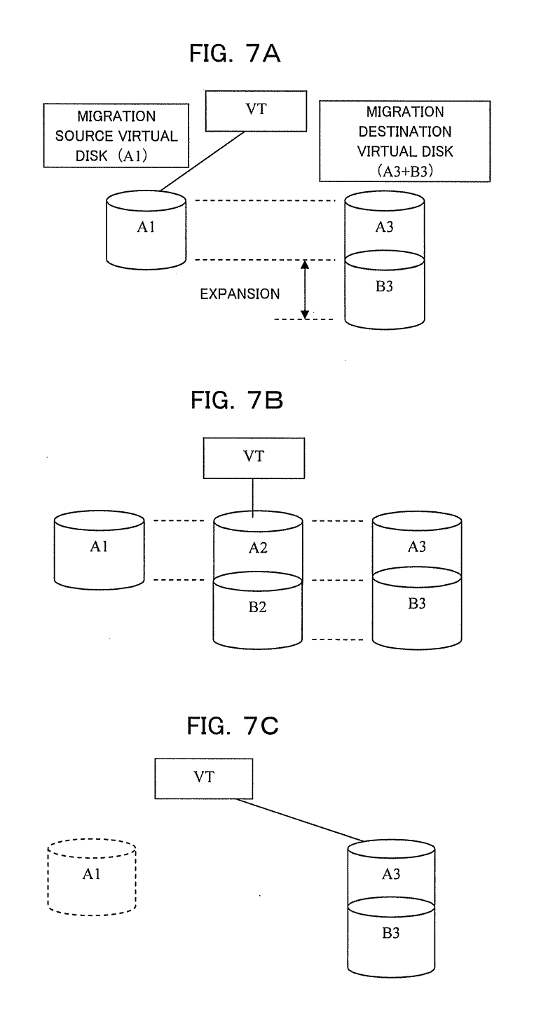

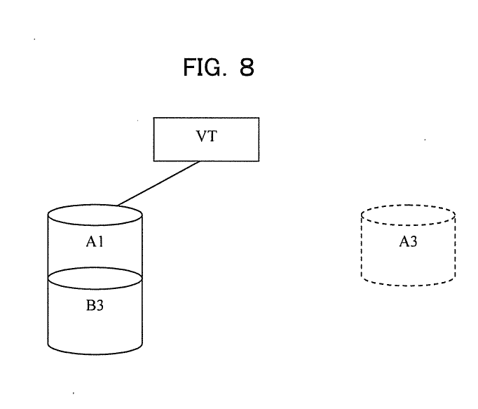

Here, operation of the storage switch 100 according to the first embodiment will be described in the following four cases. First, case 1 representing the basic operation of the storage switch 100 will be described with reference to FIGS. 7 to 7C and FIG. 8.

When an instruction to start migration processing is issued from a user, the migration destination creation section 2 creates a migration destination virtual disk having a size larger than that of a migration source virtual disk (refer to FIG. 7A).

Then, the mirror area creation section 3 creates a mirror virtual disk (represented as A2) based on the migration source virtual disk (represented as A1) and a copy size part (represented as A3) of the migration destination virtual disk (refer to FIG. 7B). The mirror area creation section 3 creates a new mirror virtual disk (A2+B2) based on the mirror virtual disk (A2) and an expanded portion (represented as B3) of the migration destination virtual disk. The VT connection section 4 connects the created virtual disk (A2+B2) to the VT (refer to FIG. 7B).

A write request to the A2 issued from the host is made to the A1 and A3 by mirroring. A read request to the A2 is made to the A1 and the target data is read out from the A1. Read and write requests to the B2 are made to the A3.

The migration processing section 5 in Case 1 performs, upon completion of the above respective processing, migration processing, i.e., data copy from the A1 to A3.

When the A1 and A3 have become equivalent, the VT connection section 4 switches the connection destination of the VT link to the migration destination virtual disk (A3+B3). The area deletion section 6 scraps the mirror and deletes the migration source virtual disk (A1) (refer to FIG. 7C).

As described above, unlike the case of general (non-expansion type) migration processing, by creating the mirror to the B3 which is the expanded area, it is possible for the storage switch 100 to process a write request that the operation server connected to the VT has issued to the expanded area (B3) through the mirror.

In Case 1, once the migration processing is started and any data is written in B3, it is unable to set the storage configuration back to a state before the migration where only the A1 exists by canceling the migration processing. Even if the cancel processing has been made, a virtual disk having a configuration of A1+B3 occurs (i.e., data exists across a migration source magnetic disk drive and a migration destination magnetic disk drive) as illustrated in FIG. 8, disabling physical replacement of the magnetic disk drive. Further, when there is a need to set the storage configuration back to the state at the time point of completion of the migration after the completion of the migration processing and start of operation, the set-back is unable to be made.

Case 2 will be described below as a means for solving the above problem.

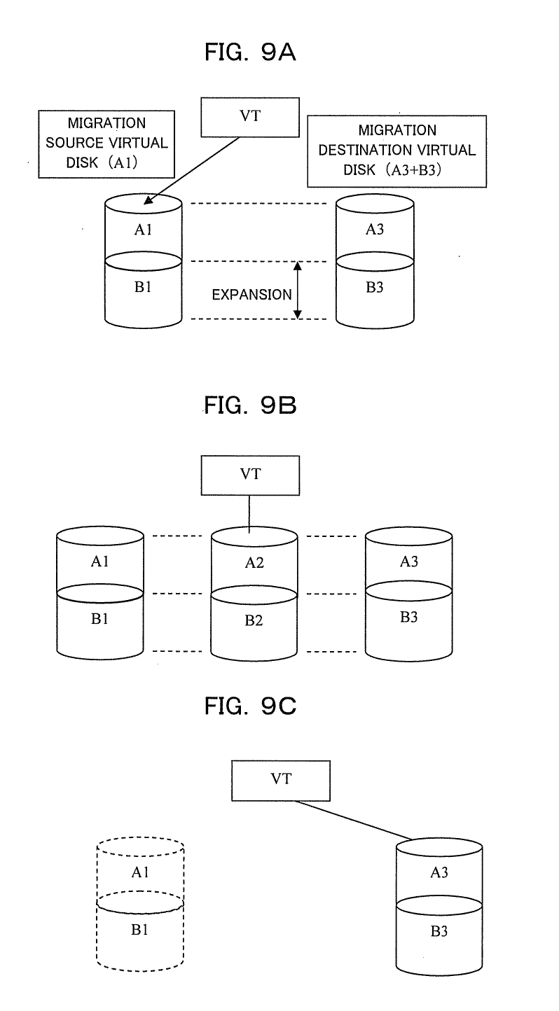

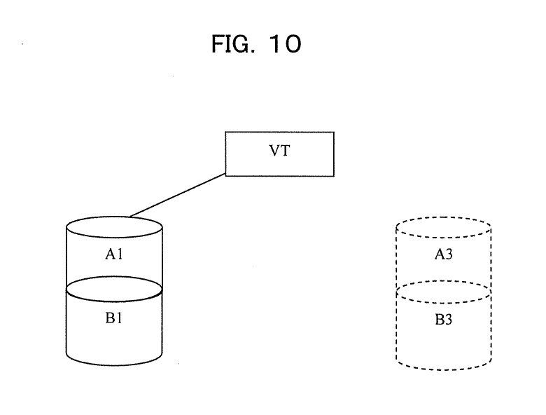

Operation (Case 2) of the storage switch 100 taken when the migration source virtual disk has an expandable storage area will be described with reference to FIGS. 9A to 9C and FIG. 10.

When there exists a capacity that can be expanded in the migration source virtual disk, both the migration source virtual disk and migration destination virtual disk are expanded so as to allow restoration to a state immediately after the completion of the migration processing (refer to FIG. 9A). In the present embodiment, creation of the expanded area (B1) of the migration source virtual disk is performed by the migration destination creation section 2.

Then, the mirror area creation section 3 creates a mirror virtual disk A2+B2 based on the migration source virtual disk A1+B1 and migration destination virtual disk A3+B3. After that, the connection section 4 connects the created mirror virtual disk A2+B2 to the VT (refer to FIG. 9B).

As in the case of the normal migration, a write request to the virtual disk A2+B2 is made to the A1+B1 and A3+B3 by mirroring. A read request to the virtual disk A2+B2 is made to the A1+B1 and the target data is read out from the A1+B1.

The expanded storage areas B1 and B3 are always equivalent by mirroring, so that the migration processing section 5 only performs migration processing from A1 to A3. When the A1 and A3 have become equivalent, the VT connection section 4 switches the connection destination of the VT link to the migration destination virtual disk (A3+B3), and the area deletion section 6 scraps the mirror (refer to FIG. 9C).

By switching the connection destination of the VT link from the A3+B3 to A1+B1 again, it is possible to restore the storage configuration to a backup state immediately after the completion of the migration processing (refer to FIG. 10).

There is a possibility that a write request may be issued to the expanded area from the operation server connected to the VT, so that once the expanded migration is started, it is unable to restore the storage configuration to its original state by performing the canceling. If the canceling is performed, only the migration from the A1 to A3 is canceled, with the result that only the virtual disk A1+B1 remains.

Although the backup state is unable to be restored in Case 1, the disk area to be used can correspondingly be saved. When performing the expanded migration, a user can arbitrarily select Case 1 or Case 2 through the processing controller 1.

Although the mirror is created after completion of the expansion of the migration destination virtual disk and then the migration processing is performed in Case 1 and Case 2, the area expansion is performed during the migration processing in the following Case 3 and Case 4.

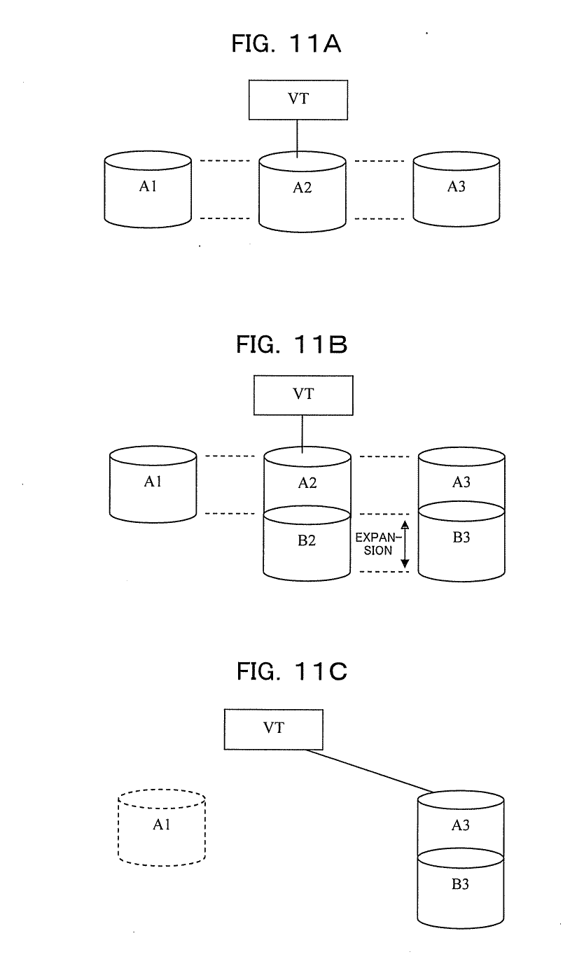

First, Case 3 will be described with reference to FIGS. 11A to 11C. At the start time, in Case 3, as in the case of the general migration, the migration destination creation section 2 ensures, as the migration destination virtual disk, a storage area having the same size as that of the migration source virtual disk in the migration destination virtual disk.

Then, the mirror area creation section 3 creates a mirror virtual disk A2 based on the migration source virtual disk (A1) and the copy size part A3 of the migration destination virtual disk. The VT connection section 4 connects the VT to the created virtual disk A2 (refer to FIG. 11A). A write request to the A2 is made to the A1 and A3 by mirroring. A read request to the A2 is made to the A1 and the target data is read out from the A1.

The migration processing section 5 performs data copy from the A1 to A3 as the migration processing. When the expansion of the storage area in the migration destination is instructed through the LAN interface 54, the migration destination creation section 2 creates an expanded area B3 and connects the created virtual disk B3 to the A3 to thereby create a migration destination virtual disk A3+B3 (refer to FIG. 11B). The mirror area creation section 3 creates a virtual disk A2+B2 based on the mirror virtual disk (A2) and the expanded area B3. The VT connection section 4 connects the virtual disk A2+B2 (B2=B3) to the VT Read and write requests to the B2 are made to the B3.

When the A1 and A3 have become equivalent by the migration processing performed by the migration processing section 5, the VT connection section 4 switches the connection destination of the VT link to the migration destination virtual disk A3+B3. After that, the area deletion section 6 scraps the mirror and deletes the migration source virtual disk A1 (refer to FIG. 11C).

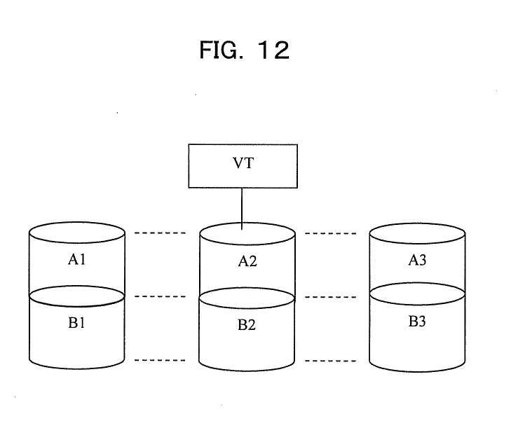

Case 4 is a case where the backup function of Case 2 has been added to Case 3. When the backup function is needed, both the migration source and migration destination are expanded as in the processing of Case 2, whereby a virtual disk B1 and a virtual disk B3 are created. Thereafter, a mirror virtual disk A2+B2 is created based on the A1+B1 and A3+B3, and the created mirror virtual disk is connected to the VT (refer to FIG. 12).

A write request to the virtual disk A2+B2 is made to the A1+B1 and A3+B3 as in the case of the normal migration by mirroring. A read request to the virtual disk A2+B2 is made to the A1+B1 and the target data is read out from the A1+B1. Like Case 2, the migration processing section 5 only performs migration from A1 to A3.

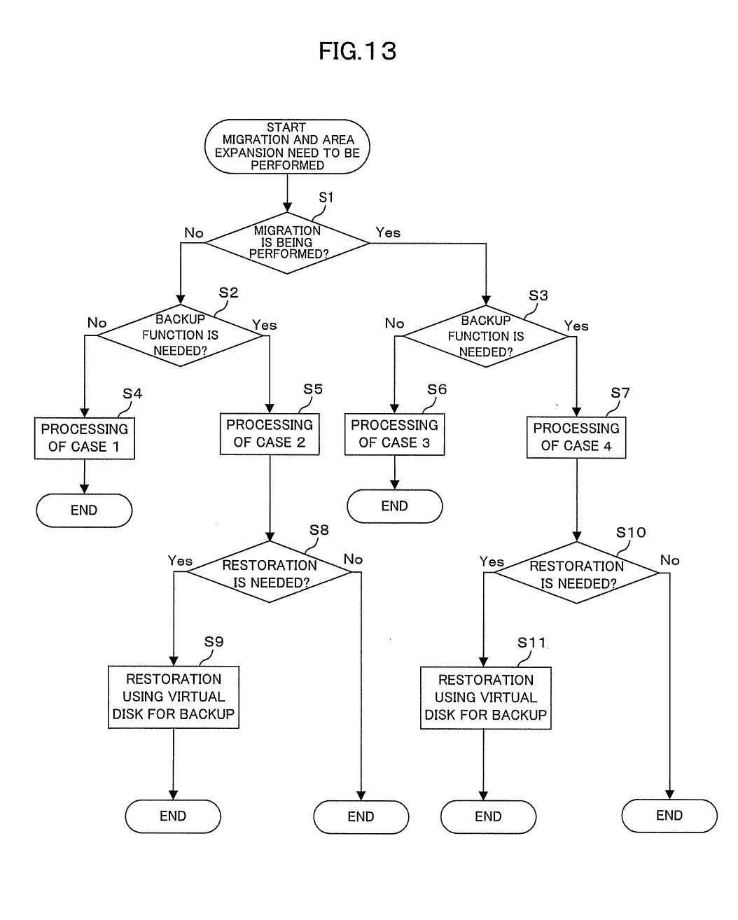

Next, processing performed by the storage switch 100 in the first embodiment will be described with reference to flowcharts and data structure diagrams of FIG. 13 to FIGS. 23A, 23B. First, processing performed by the processing controller 1 which is a unit for controlling the processing of Case 1 to Case 4 will be described with reference to FIG. 13.

The processing controller 1 receives an instruction to start migration processing from a user through the LAN interface 54. After that, the processing controller 1 determines whether the migration processing by the migration processing section 5 is being performed or not (S1).

When the migration processing is not being performed (No in S1), the processing controller 1 determines whether the backup function is needed or not (S2). When the backup function is not needed (No in S2), the processing of Case 1 is performed (S4). On the other hand, the backup function is needed (Yes in S2), the processing of Case 2 is performed (S5). When there is a need to perform restoration after the completion of the processing of Case 2 (Yes in S8), the VT is connected back to a virtual disk onto which data has been backed up for the data restoration (S9).

When the migration processing is being performed (Yes in S1), the processing controller 1 determines whether the backup function is needed (S3). When the backup function is not needed (No in S3), the processing of Case 3 is performed (S6). When the backup function is needed (Yes in S3), the processing of Case 4 is performed (S7). When there is a need to perform restoration after the completion of the processing of S7 (Yes in S10), the VT is connected back to a virtual disk onto which data has been backed up for the data restoration (S11).

The determination of S1 is made based on a function which is provided in the processing controller 1 so as to monitor the operation state of the migration processing section 5. The determinations of S2 and S3 are made based on whether the bit value of a predetermined flag in a message included in the migration processing start instruction from a user is 0 or 1. Further, in S8 and S10, in the case where the storage switch 100 has received a predetermined message from a user, it is determined that the restoration is needed.

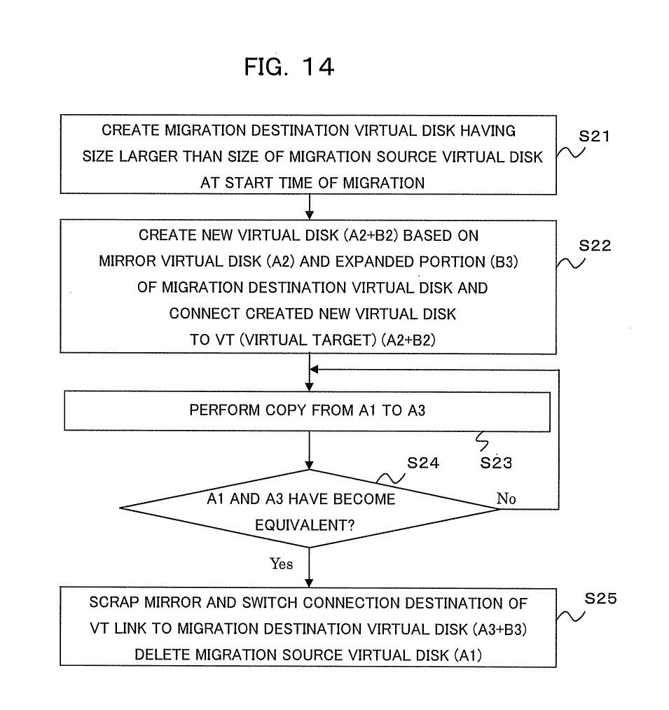

The processing of Case 1 (S4 in FIG. 13) will be described with reference to a flowchart of FIG. 14. The following description concerning Case 1 will be made based on the disk configuration illustrated in FIGS. 7A to 7C, so that it is preferable to refer to FIGS. 7A to 7C as needed.

The migration destination creation section 2 creates a migration destination virtual disk having a size larger than that of a migration source virtual disk (S21). The migration destination creation section 2 then creates the virtual disk management tables of the migration destination virtual disk A3 and B3. The device address, size, and the like of a real disk corresponding to the virtual disk are set based on instruction information from a management server. In the following explanations, The virtual disk management table of the same number as a virtual disk is a virtual disk management table of the virtual disk.

The mirror area creation section 3 creates a mirror virtual disk A2 based on the migration source virtual disk (A1) and the copy size part A3 of the migration destination virtual disk and creates a new mirror virtual disk A2+B2 based on the mirror virtual disk A2 and an expanded portion B3 of the migration destination virtual disk. The VT connection section 4 connects the created mirror virtual disk A2+B2 to the VT (S22).

The migration processing section 5 performs copy from the A1 to A3 until the A1 and A3 become equivalent (S23 and loop of No in S24).

When the A1 and A3 have become equivalent (Yes in S24), the VT connection section 4 switches the connection destination of the VT link to the migration destination virtual disk (A3+B3). The area deletion section 6 scraps the mirror and deletes the migration source virtual disk A1 (S25).

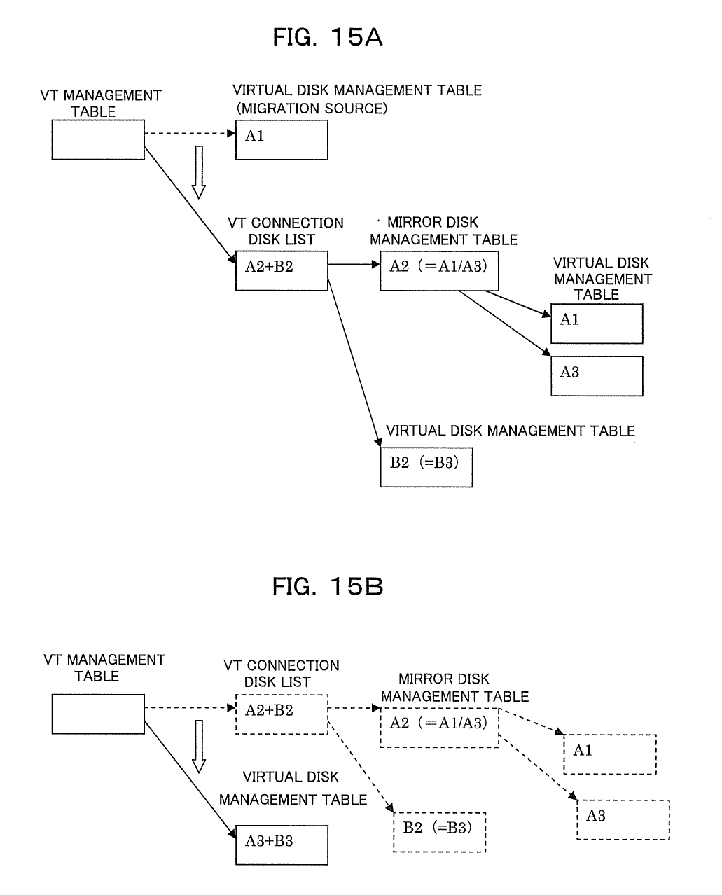

Details of the processing of S22 will be described with reference to FIG. 15A. The mirror area creation section 3 creates a mirror disk management table A2 and registers the virtual disk management tables of the migration source virtual disk A1 and migration destination virtual disk A3 in the mirror disk management table A2. After that, the mirror area creation section 3 creates a new VT connection disk list and registers the mirror disk management table A2 and virtual disk management table B2 (=B3) in the VT connection disk list.

The VT connection section 4 replaces the pointer of the VT management table pointing to the virtual disk management table A1 by a pointer pointing to the VT connection disk list to which the mirror disk management table A2 and the virtual disk management table B3 are registered.

Details of the processing of S25 will be described with reference to FIG. 15B. The VT connection section 4 creates a new virtual disk management table A3+B3 based on the virtual disk management table A3 and virtual disk management table B3 and replaces the pointer of the VT management table pointing to the VT connection disk list A2+B2 by a pointer pointing to the virtual disk management table A3+B3. The area deletion section 6 deletes the virtual disk management table A1 and mirror disk management table A2.

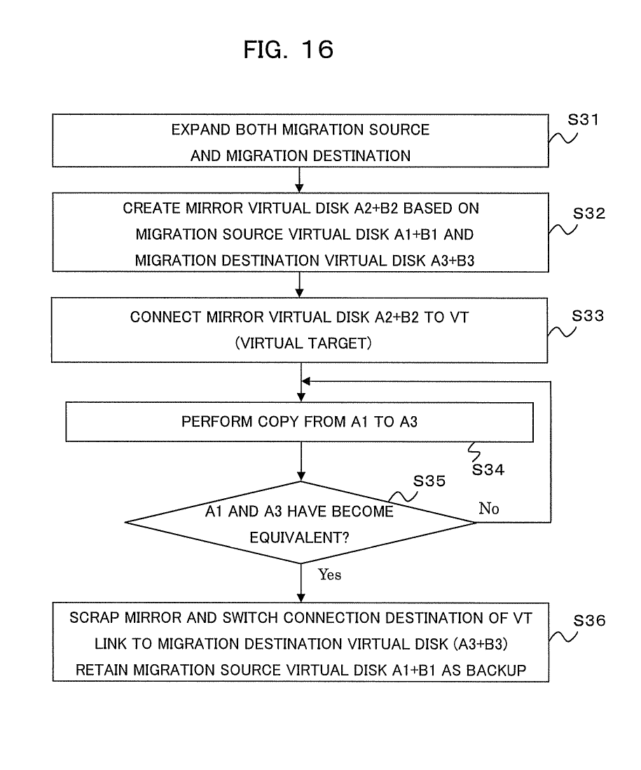

The processing of Case 2 (S5 in FIG. 13) will be described with reference to a flowchart of FIG. 16. The following description concerning Case 2 will be made based on the disk configuration illustrated in FIGS. 9A to 9C, so that it is preferable to refer to FIGS. 9A to 9C as needed.

When there exists a capacity that can be expanded in the migration source virtual disk, both the migration source virtual disk and migration destination virtual disk are expanded (S31). As a result, a virtual disk management table A1+B1 of the expanded migration source virtual disk and virtual disk management table A3+B3 of the expanded migration destination virtual disk are created. A virtual disk management table A1 before the expansion is deleted. The device address, size, and the like of a real disk corresponding to the virtual disk are set based on instruction information from a management server.

The mirror area creation section 3 creates a mirror virtual disk A2+B2 based on the migration source virtual disk A1+B1 and migration destination virtual disk A3+B3 (S32). Thereafter, the VT connection section 4 connects the created mirror virtual disk A2+B2 to the VT (S33).

The migration processing section 5 performs migration processing from the A1 to A3 until the A1 and A3 become equivalent (S34 and loop of No in S35). When the A1 and A3 have become equivalent (Yes in S35), the VT connection section 4 switches the connection destination of the VT link to the migration destination virtual disk A3+B3. The area deletion section 6 scraps the mirror (S36). The area of A1+B1 is retained as a backup.

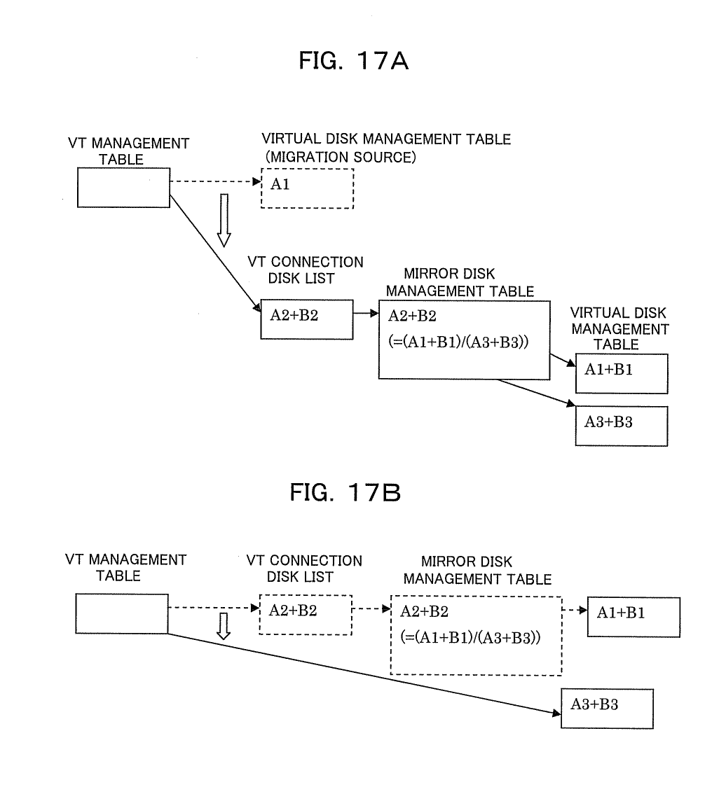

Details of the processing of S32 and S33 will be described with reference to FIG. 17A. The mirror area creation section 3 creates a mirror disk management table A2+B2 and registers a virtual disk management table A2+B2 of the migration source virtual disk A1+B1 and migration destination virtual disk A3+83 in the mirror disk management table. After that, the mirror area creation section 3 creates a VT connection disk list and registers the mirror disk management table A2+B2 in the VT connection disk list.

The VT connection section 4 replaces the pointer of the VT management table pointing to the migration source virtual disk by a pointer pointing to the created VT connection disk list A2+B2.

Details of the processing of S36 will be described with reference to FIG. 17B. The VT connection section 4 replaces the pointer of the VT management table pointing to the VT connection disk list A2+B2 by a pointer pointing to the virtual disk management table A3+B3. The area deletion section 6 deletes the mirror disk management table A2+B2 and VT connection disk list A2+B2. The virtual disk management table A1+B1 is retained for backup use.

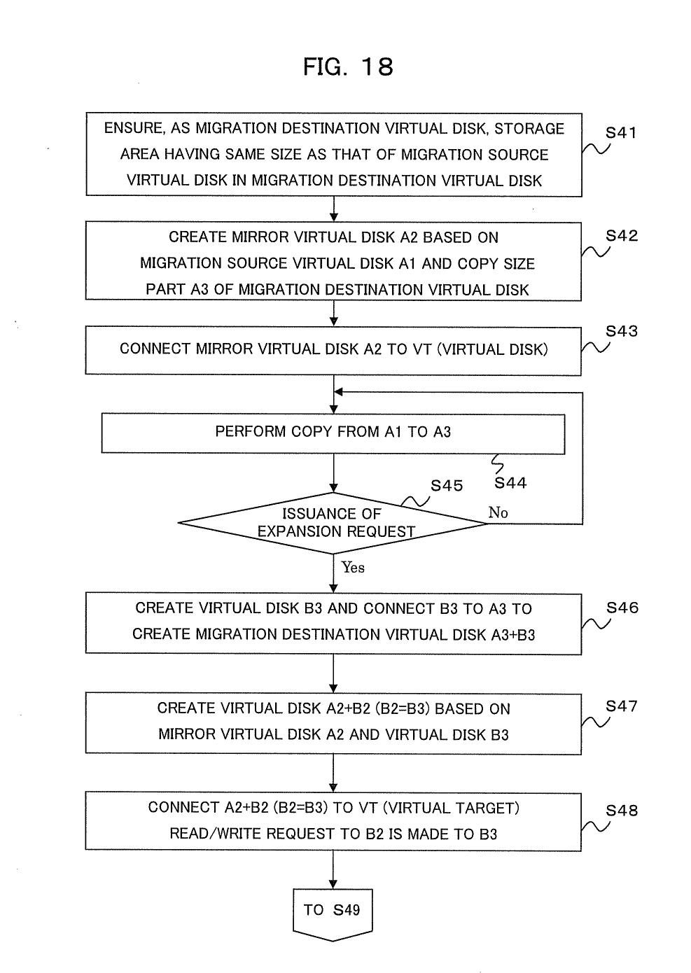

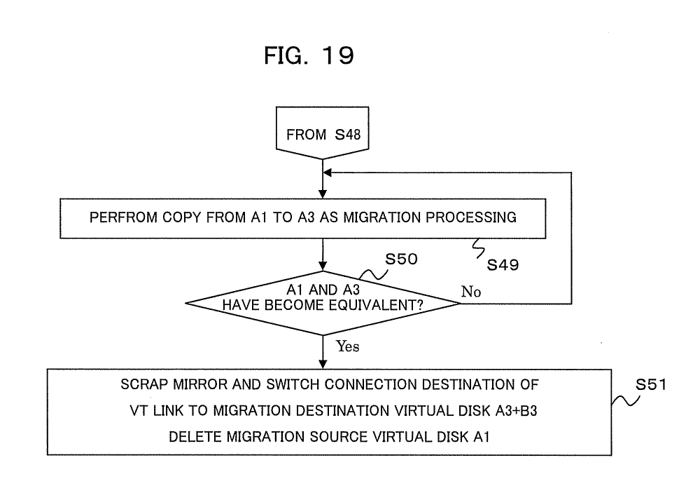

The processing of Case 3 (S6 in FIG. 13) will be described with reference to flowcharts of FIGS. 18 and 19. The following description concerning Case 3 will be made based on the disk configuration illustrated in FIGS. 11A to 11C, so that it is preferable to refer to FIGS. 11A to 11C as needed.

The migration destination creation section 2 ensures, as the migration destination virtual disk, a storage area having the same size as that of the migration source virtual disk in the migration destination virtual disk (S41). The migration destination creation section 2 then creates a virtual disk management table A3 of the migration destination virtual disk. The device address of a real disk corresponding to the virtual disk is set based on instruction information from a management server.

Then, the mirror area creation section 3 creates a mirror virtual disk A2 based on the migration source virtual disk A1 and the copy size part A3 of the migration destination virtual disk (S42). The VT connection section 4 connects the created virtual disk A2 to the VT (S43).

The migration processing section 5 performs copy from the A1 to A3 as migration processing (S44). When an instruction to expand the area of the migration destination has been issued through the LAN interface 54 (Yes in S45), the migration destination creation section 2 creates a virtual disk B3 and connects the B3 to the A3 to create a migration destination virtual disk A3+B3 (S46).

The mirror area creation section 3 creates a virtual disk A2+B2 based on the mirror virtual disk A2 and virtual disk 83 (S47). The VT connection section 4 connects the created virtual disk A2+82 (B2=B3) to the VT (S48).

The migration processing section 5 ongoingly performs copy from the A1 to A3 as migration processing until the A1 and A3 become equivalent (S49 and loop of No in S50). When the A1 and A3 have become equivalent (Yes in S50), the VT connection section 4 switches the connection destination of the VT link to the migration destination virtual disk A3+B3. The area deletion section 6 scraps the mirror and deletes the migration source virtual disk A1 (S51).

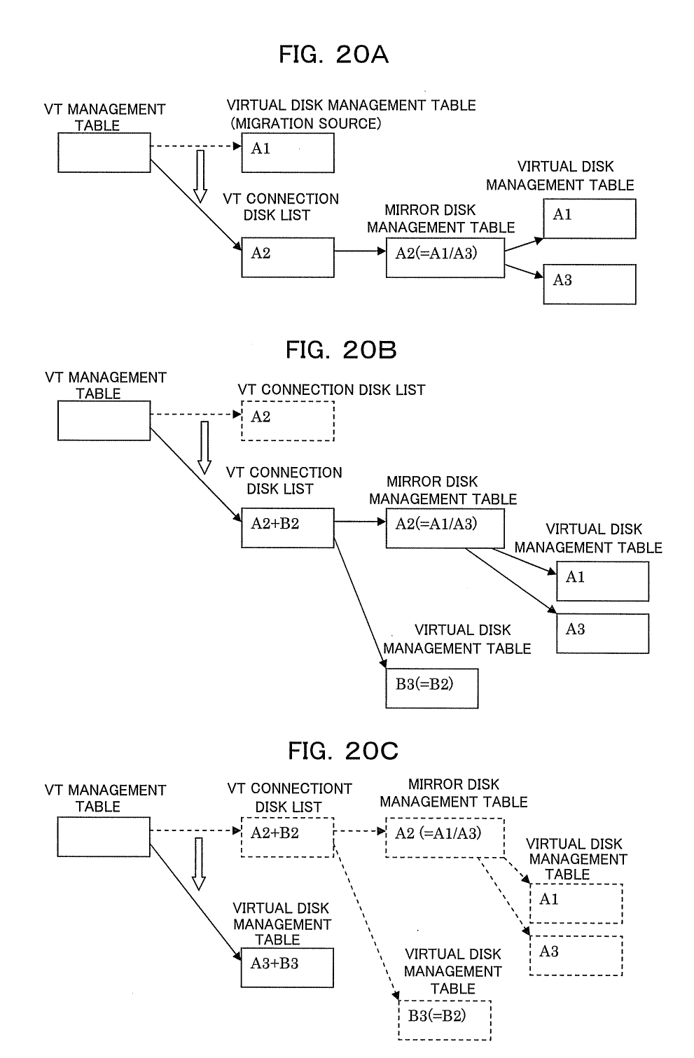

Details of the processing of S42 and S43 will be described with reference to FIG. 20A. The mirror area creation section 3 creates a mirror disk management table A2 and registers the virtual disk management table A1 of the migration source virtual disk and virtual disk management table A3 of the migration destination virtual disk in the mirror disk management table A2. After that, the mirror area creation section 3 creates a VT connection disk list A2 and registers the mirror disk management table A2 in the VT connection disk list. The VT connection section 4 replaces the pointer of the VT management table pointing to the virtual disk management table A1 of the migration source virtual disk by a pointer pointing to the VT connection disk list A2.

Details of the processing of S46, S47, and S48 will be described with reference to FIG. 20B. The migration destination creation section 2 creates a virtual disk management table B3 corresponding to the expanded area of the migration destination virtual disk. The device address, size, and the like of a real disk corresponding to the virtual disk are set based on instruction information from a management server. The mirror area creation section 3 creates a VT connection disk list (A2+B2) and registers the mirror disk management table A2 and virtual disk management table B2 (=B3) in the VT connection disk list A2+B2. The VT connection section 4 replaces the pointer of the VT management table pointing to the VT connection disk list A2 by a pointer pointing to the VT connection disk list A2+B2.

Details of the processing of S51 will be described with reference to FIG. 20C. The VT connection section 4 creates a new virtual disk management table A3+B3 based on the virtual disk management table A3 and virtual disk management table (B3) and replaces the VT connection disk list A2+B2 of the VT management table by the created virtual disk management table A3+B3. The area deletion section 6 deletes the VT connection list A2+B2, virtual disk management tables A1, A3, and B3 (=B2), and mirror disk management table A2.

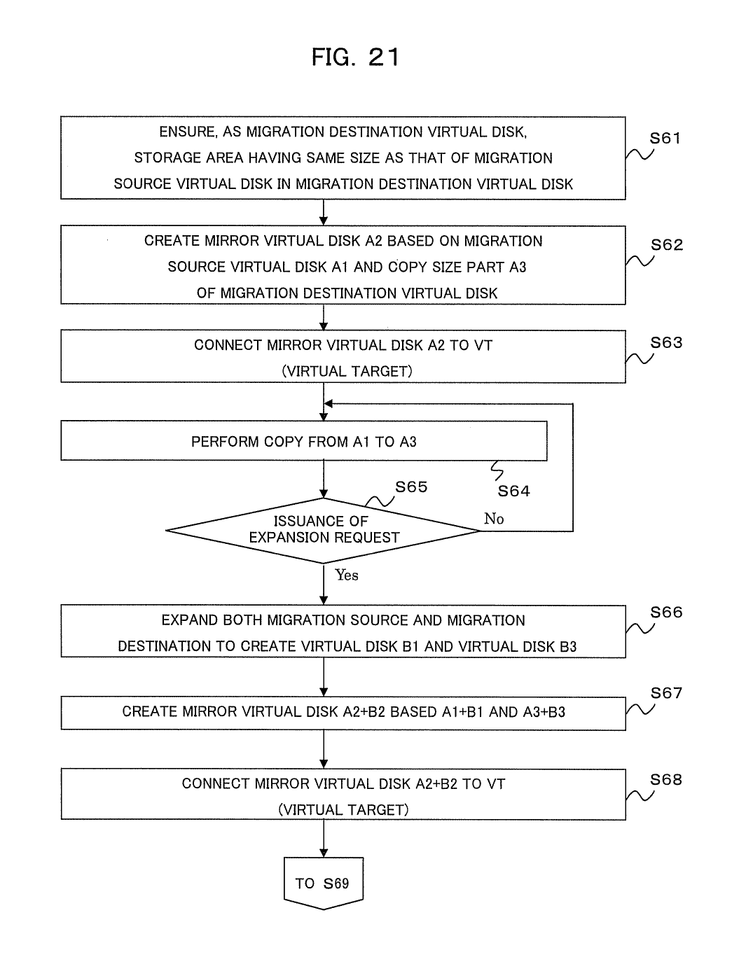

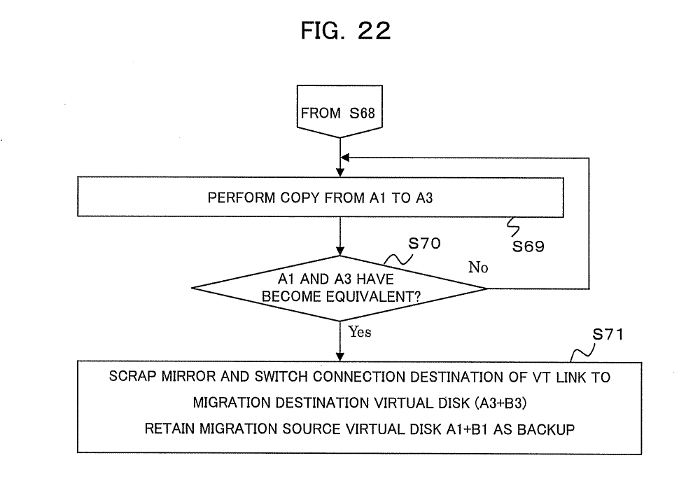

The processing of Case 4 (S7 in FIG. 13) will be described with reference to flowcharts of FIGS. 21 and 22. The processing from S61 to S65 is the same as the processing from S41 to 345 of Case 3, so that the description thereof will be omitted.

When an area expansion request occurs (Yes in S65), both the migration source virtual disk and migration destination virtual disk are expanded as in the case of the processing of Case 2 and, thereby, a virtual disk 81 and a virtual disk 83 are created (S66). The processing of S66 corresponds to the processing of S31 in FIG. 16.

Then, a mirror virtual disk A2+B2 is created based on the A1+B1 and A3+B3 (S67). The processing of S67 corresponds to the processing of S32 in FIG. 16. The created mirror virtual disk is connected to the VT (refer to S68). The processing of S68 corresponds to the processing of S33 in FIG. 16.

The migration processing section 5 ongoingly performs copy from the A1 to A3 as migration processing until the A1 and A3 become equivalent (S69 and loop of No in S70). When the A1 and A3 have become equivalent (Yes in S70), the VT connection section 4 switches the connection destination of the VT link to the migration destination virtual disk A3+B3, and the area deletion section 6 scraps the mirror (S71). The A1+B1 is retained as a backup.

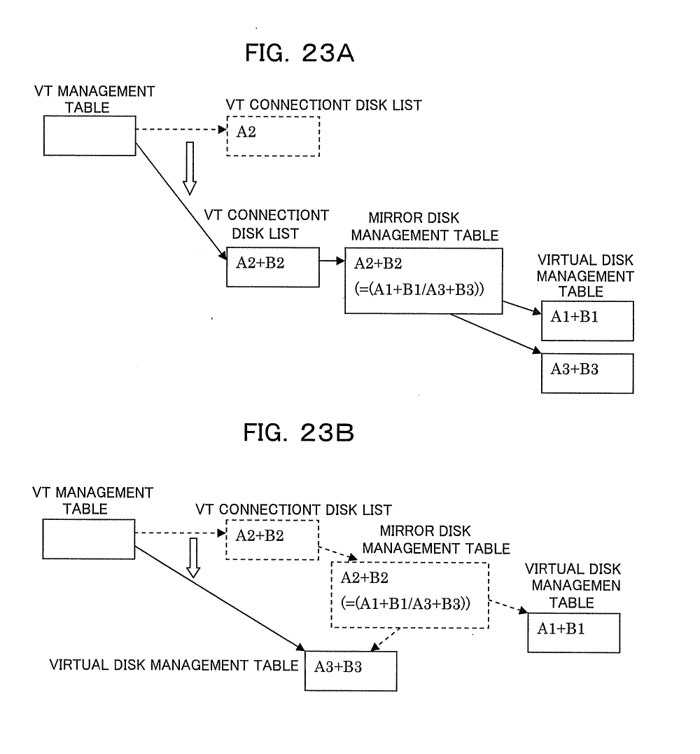

Details of the processing of S66, S67, and S68 will be described with reference to FIG. 23A. The migration source virtual disk A1 is expanded and a migration source virtual disk A1+B1 is created. The device address, size, and the like of a real disk corresponding to the B1 are set based on instruction information from a management server. Further, the migration destination virtual disk A3 is expanded and a migration source virtual disk A3+B3 is created. The device address, size, and the like of a real disk corresponding to the B3 are set based on instruction information from a management server.

The migration destination creation section 2 creates a virtual disk management table A1+B1 and a virtual disk management table A3+B3. The mirror area creation section 3 creates a mirror disk management table A2+B2 (=(A1+B1)/(A3+B3)). Further, the mirror area creation section 3 creates a VT connection disk list (A2+B2) and registers the mirror disk management table (A2+B2) in the created VT connection disk list (A2+B2).

The VT connection section 4 replaces the pointer of the VT management table pointing to the VT connection disk list (A2) by a pointer pointing to the VT connection disk list (A2+B2).

Details of the processing of S71 will be described with reference to FIG. 23B. The VT connection section 4 replaces the pointer of the VT management table pointing to the VT connection disk list (A2+B2) by a pointer pointing to the virtual disk management table (A3+B3). The area deletion section 6 deletes the VT connection disk list (A2+B2) and mirror disk management table (A2+B2). The virtual disk management table (A1+B1) is retained for backup use.

### Second Embodiment

While the migration processing for expanding the storage capacity of the virtual disk has been described in the above first embodiment, migration processing for reducing the storage capacity of the virtual disk will be described in the following second embodiment.

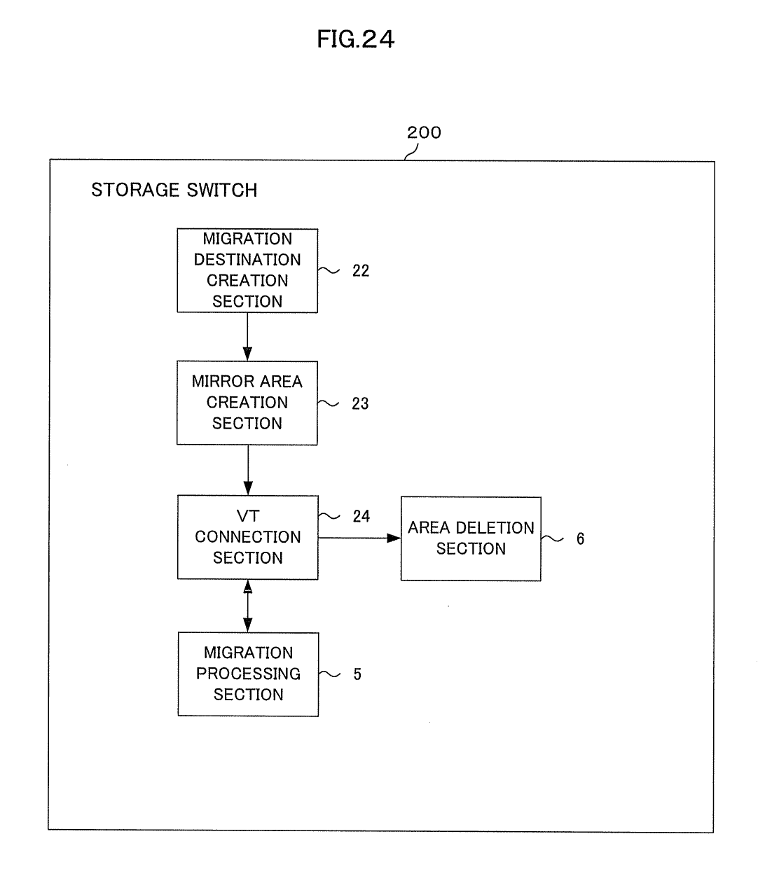

FIG. 24 illustrates a functional block of the storage switch according to the second embodiment. The hardware configuration of the storage switch according to the second embodiment is the same as that of the storage switch 100 according to the first embodiment, so that the description thereof will be omitted.

A storage switch 200 includes a migration destination creation section 22 (migration destination storage area creation section), a mirror area creation section 23 (first mirror area creation section), a VT connection section 24 (virtual target connection section), a migration processing section 5 (data migration section), and an area deletion section 6.

The migration destination creation section 22 creates a migration destination virtual disk (data migration destination storage area) which is a storage area having a capacity smaller than that of a migration source virtual disk (data migration source storage area).

The mirror area creation section 23 creates a storage area (referred to as a first storage area) having a size equal to that of the migration destination virtual disk in the migration source virtual disk and then creates a mirror area for performing control so that processing corresponding to a write request issued from a host to the migration source virtual disk is executed between the first storage area and migration source virtual disk.

The VT connection section 24 connects the first mirror area created by the mirror area creation section 23 to a virtual target serving as an interface for receiving a read/write request issued from the host.

The functions of the migration processing section 5 and area deletion section 6 are the same as those in the first embodiment.

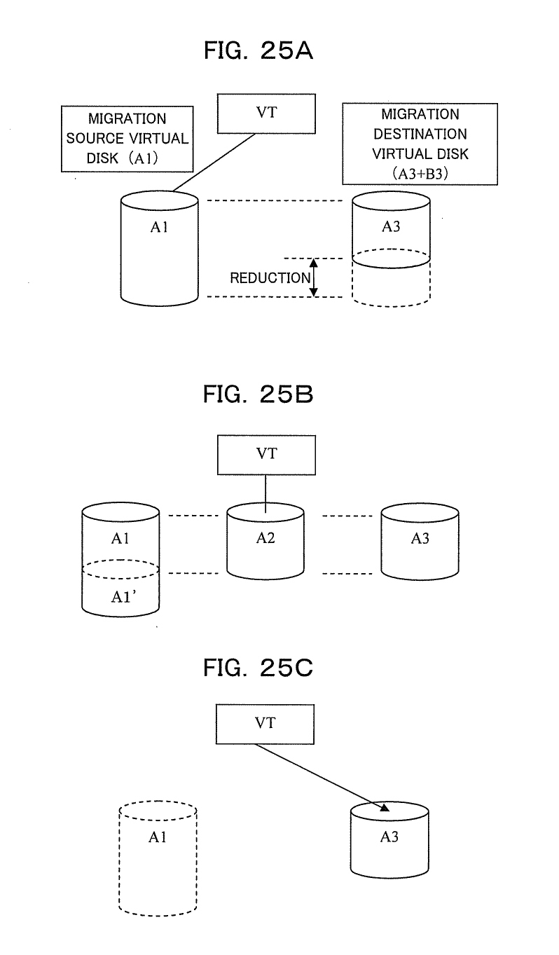

Operation of the storage switch 200 according to the second embodiment will be described with reference to FIGS. 25A to 25C.

At the start of the migration, the migration destination creation section 22 creates a migration destination virtual disk having a size (A3) smaller than that of a migration source virtual disk (A1) (refer to FIG. 25A).

Then, the mirror area creation section 23 creates a mirror virtual disk (A2) corresponding to the migration target part of the migration source virtual disk which is obtained by removing A1′ in FIGS. 25A to 25C and migration destination virtual disk (A3). Then, the VT connection section 24 connects the VT to the mirror virtual disk (A2) (FIG. 25B).

A write request to the A2 is made to the A1 and A3 by mirroring. A read request to the A2 is made to the A1 and the target data is read out from the A1. Data of the A1′ is not mapped to the mirror disk A2, so that the A1′ is unable to be accessed.

The migration processing section 5 performs copy from the A1 to A3 as migration processing.

When the A1 and A3 have become equivalent, the VT connection section 24 switches the connection destination of the VT link to the migration destination virtual disk (A3). The area deletion section 6 scraps the mirror and deletes the migration source virtual disk (A1).

When canceling is performed during the reduced migration, the connection destination of the VT link is switched from the mirror disk A2 to virtual disk A1, and the mirror disk (A2) is deleted.

When a backup state needs to be restored after migration, the connection destination of the VT link is switched from the virtual disk A3 to virtual disk A1.

After the start of the reduced migration, the reduced area is unable to be accessed and data that has been written therein is discarded, so that at the time of use of this function, some mechanism needs to be employed to previously prevent the reduced area to be used by a file system on the operation server.

According to the above embodiments of the present invention, the migration and change of the storage area size can be realized by a single user operation, thereby reducing user's workload. Further, data write to the changed area can be performed during the migration processing, thereby increasing user convenience.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage switch comprising:
a migration destination storage area creation section that creates a data migration destination storage area which is a storage area to which data is migrated and has a capacity larger than that of a data migration source storage area which is a storage area from which data is migrated;
a first mirror area creation section that creates, in the data migration destination storage area, a first storage area having a size equal to that of the data migration source storage area and creates a first mirror area for performing control so that processing corresponding to a write request issued from a host to the data migration source storage area is executed between the first storage area and data migration source storage area;
a second mirror area creation section that creates, in the data migration source storage area, a second storage area different from the first storage area and creates a second mirror area for performing control so that processing corresponding to a write request issued from a host to the second storage area is executed in the second storage area;
a combined mirror area creation section that combines the first and second mirror areas to create a combined mirror area;
a virtual target connection section that connects a virtual target serving as an interface for receiving a read/write request issued from a host to the combined mirror area; and
a data migration section that performs data migration from the data migration source storage area to the first storage area.

2. The storage switch according to claim 1, further comprising
a connection switching section that switches the connection destination of the virtual target from the combined mirror area to the data migration destination storage area upon completion of the data migration from the data migration source storage area to the first storage area performed by the data migration section.

3. The storage switch according to claim 2, further comprising
an invalidation section that invalidates the data migration source storage area after the connection destination of the virtual target is switched to data migration destination storage area by the connection switching section.

4. The storage switch according to claim 1, wherein
the first mirror area created by the first mirror area creation section further performs control so that processing corresponding to a read request issued from a host to the data migration source storage area is executed in the data migration source storage area, and
the second mirror area created by the second mirror area creation section further performs control so that processing corresponding to a read request issued from a host to the second storage area is executed in the second storage area.

5. The storage switch according to claim 1, wherein,
in the case where the data migration source storage area has a storage area that can be expanded,
the second mirror area created by the second mirror area creation section further performs control so that processing corresponding to a read/write request issued from a host to the second storage area is also executed in the storage area that can be expanded.

6. The storage switch according to claim 1, wherein
the data migration section performs data migration after the virtual target is connected to the combined mirror area by the virtual target connection section.

7. The storage switch according to claim 1, further comprising
a first mirror area connection section that connects the virtual target serving as an interface for receiving a read/write request from a host to the first mirror area, wherein
the data migration section performs data migration after the virtual target is connected to the first mirror area by the first mirror area connection section, and
the second mirror area creation section, combined mirror area creation section, and virtual target connection section perform their respective processing during the data migration performed by the data migration section.

8. A storage switch comprising:
a migration destination storage area creation section that creates a data migration destination storage area which is a storage area to which data is migrated and has a capacity smaller than that of a data migration source storage area which is a storage area from which data is migrated;
a first mirror area creation section that creates, in the data migration source storage area, a first storage area having a size equal to that of the data migration destination storage area and creates a first mirror area for performing control so that processing corresponding to a write request issued from a host to the data migration source storage area is executed between the first storage area and data migration source storage area;
a virtual target connection section that connects a virtual target serving as an interface for receiving a read/write request issued from a host to the first mirror area; and
a data migration section that performs data migration from the data migration source storage area to the first storage area.

9. A storage area size change method executed by a storage switch, comprising:
creating a data migration destination storage area which is a storage area to which data is migrated and has a capacity larger than that of a data migration source storage area which is a storage area from which data is migrated;
creating, in the data migration destination storage area, a first storage area having a size equal to that of the data migration source storage area and creating a first mirror area for performing control so that processing corresponding to a write request issued from a host to the data migration source storage area is executed between the first storage area and data migration source storage area;
creating, in the data migration source storage area, a second storage area different from the first storage area and creates a second mirror area for performing control so that processing corresponding to a write request issued from a host to the second storage area is executed in the second storage area;
combining the first and second mirror areas to create a combined mirror area;
connecting a virtual target serving as an interface for receiving a read/write request issued from a host to the combined mirror area; and
performing data migration from the data migration source storage area to the first storage area.

10. The storage area size change method according to claim 9, further comprising
switching the connection destination of the virtual target from the combined mirror area to the data migration destination storage area upon completion of the data migration from the data migration source storage area to the first storage area.

11. The storage area size change method according to claim 10, further comprising
invalidating the data migration source storage area after the connection destination of the virtual target is switched to data migration destination storage area.

12. The storage area size change method according to claim 9, wherein
the first mirror area further performs control so that processing corresponding to a read request issued from a host to the data migration source storage area is executed in the data migration source storage area, and
the second mirror area further performs control so that processing corresponding to a read request issued from a host to the second storage area is executed in the second storage area.

13. The storage area size change method according to claim 9, wherein,
in the case where the data migration source storage area has a storage area that can be expanded,
the second mirror area further performs control so that processing corresponding to a read/write request issued from a host to the second storage area is also executed in the storage area that can be expanded.

14. The storage area size change method according to claim 9, wherein
data migration from the data migration source storage area to the first storage area is performed after the virtual target is connected to the combined mirror area.

15. The storage area size change method according to claim 9, further comprising
connecting the virtual target serving as an interface for receiving a read/write request from a host to the first mirror area, wherein
the data migration from the data migration source storage area to the first storage area is performed after the virtual target is connected to the first mirror area, and
creation of the second mirror area creation section, creation of the combined mirror area creation section, and connection of the virtual target to the combined mirror area are performed during the data migration from the data migration source storage area to the first storage area.
